(19) United States
(12) Patent Application Publication
(10) Pub. No.: US 2025/0178646 A1
(43) Pub. Date: Jun. 5, 2025

(54) SELF-DRIVING TAKEOVER DETERMINING METHOD AND SYSTEM THEREOF

(71) Applicant: Automotive Research & Testing Center, Changhua County (TW)

(72) Inventors: Yi Feng SU, Changhua County (TW); Yu-Chieh WANG, Changhua County (TW); Chih-Ho SUN, Changhua County (TW)

(21) Appl. No.: 18/523,923

(22) Filed: Nov. 30, 2023

(51) Int. Cl. B60W 60/00; B60W 40/08; B60W 50/00; B60W 50/14; B60W 50/16; G06V 10/70; G06V 20/59; G06V 40/16; G06V 40/18

(52) U.S. Cl. CPC B60W 60/0059; B60W 40/08; B60W 50/16; B60W 60/0051; G06V 10/70; G06V 20/593; G06V 20/597; G06V 40/161; G06V 40/18; B60W 2040/0872; B60W 2040/0881; B60W 2050/0083; B60W 2050/143; B60W 2050/146; B60W 2420/403; B60W 2540/221; B60W 2540/223; B60W 2540/225; B60W 2540/227

(57) ABSTRACT

A self-driving takeover determining method is for determining whether a driver located on a driver's seat in a vehicle satisfies a self-driving takeover condition in a self-driving mode. The self-driving takeover determining method includes a driver calibrating step, a detection module updating step, an image capturing step, a face detecting step, a driver availability determining step and a self-driving takeover determining step. The driver calibrating step includes, before entering the self-driving mode of the vehicle, capturing a plurality of calibration images of the driver by at least one camera and generating a plurality of driver calibration parameters by a calibration module according to the calibration images, and the driver calibration parameters are a plurality of relative position parameters of the driver in a cockpit of the vehicle. The detection module updating step includes updating a detection module according to the driver calibration parameters.

### BACKGROUND

### Technical Field

The present disclosure relates to a self-driving takeover determining method and a system thereof. More particularly, the present disclosure relates to a self-driving takeover determining method and a system thereof based on driver images.

### Description of Related Art

While the self-driving market is growing, how to improve the safety to reduce the occurrence of accidents thereof is always a priority consideration in the development of self-driving vehicles. For Level 3 self-driving vehicles of SAE (Society of Automation Engineers), the driver is not required to hold the steering wheel under certain conditions. However, the driver must have the ability to take over the driving task. Therefore, the development focus of Level 3 self-driving vehicles is to detect whether the driver is conscious and can take over the driving task at any time, rather than focusing on detecting the driver's concentration as Level 0 to Level 2 self-driving modes.

Given the above, how to develop a self-driving takeover determining method and a system thereof, which can appropriately and accurately detect whether a driver of a Level 3 self-driving vehicle has an ability to take over the driving task, has become an urgent issue in the self-driving market.

### SUMMARY

According to one aspect of the present disclosure, a self-driving takeover determining method is for determining whether a driver located on a driver's seat in a vehicle satisfies a self-driving takeover condition in a self-driving mode. The self-driving takeover determining method includes a driver calibrating step, a detection module updating step, an image capturing step, a face detecting step, a driver availability determining step and a self-driving takeover determining step. The driver calibrating step includes, before entering the self-driving mode of the vehicle, capturing a plurality of calibration images of the driver by at least one camera and generating a plurality of driver calibration parameters by a calibration module according to the calibration images, and the driver calibration parameters are a plurality of relative position parameters of the driver in a cockpit of the vehicle. The detection module updating step includes updating a detection module according to the driver calibration parameters. The image capturing step includes, during a first detection time period in the self-driving mode, capturing a plurality of driver images of the driver by the camera. The face detecting step includes, by the detection module according to the driver images, detecting whether the driver satisfies at least one face characteristic condition, which is at least one face detection result. The driver availability determining step includes, by an availability determination module according to the at least one face detection result, determining whether the driver satisfies an availability condition, which is an availability determination result. The self-driving takeover determining step includes determining whether the self-driving takeover condition is satisfied according to the availability determination result.

According to another aspect of the present disclosure, a self-driving takeover determining system is disposed on a vehicle and includes a self-driving unit, at least one camera, a processing unit and an on-board communication network. The self-driving unit is configured for executing a self-driving mode of the vehicle. The at least one camera is configured for capturing a plurality of driver images of a driver located on a driver's seat in the vehicle. The processing unit includes a calibration module, a detection module and an availability determination module. The on-board communication network is configured for communicatively connecting the self-driving unit, the camera and the processing unit. The processing unit is configured to: before entering the self-driving mode of the vehicle, capture a plurality of calibration images of the driver by at least one camera and generate a plurality of driver calibration parameters by the calibration module according to the calibration images, wherein the driver calibration parameters are a plurality of relative position parameters of the driver in a cockpit of the vehicle; update the detection module according to the driver calibration parameters; during a first detection time period in the self-driving mode, capture a plurality of driver images of the driver by the camera; by the detection module according to the driver images, detect whether the driver satisfies at least one face characteristic condition, which is at least one face detection result; by the availability determination module according to the at least one face detection result, determine whether the driver satisfies an availability condition, which is an availability determination result; and determine whether a self-driving takeover condition is satisfied according to the availability determination result.

### BRIEF DESCRIPTION OF THE DRAWINGS

The present disclosure can be more fully understood by reading the following detailed description of the embodiment, with reference made to the accompanying drawings as follows:

FIG. 1 is a flow chart of a self-driving takeover determining method according to the 1st embodiment of the present disclosure.

FIG. 2 is a block diagram of a self-driving takeover determining system according to the 2nd embodiment of the present disclosure.

FIG. 3 is a schematic view of a vehicle, on which the self-driving takeover determining system in FIG. 2 is disposed.

FIG. 4 is another schematic view of the vehicle, on which the self-driving takeover determining system in FIG. 2 is disposed.

FIG. 5 is a schematic view of an eye state characteristic value in the eye-opening detecting step in FIG. 1.

FIG. 6 is a schematic view of the eye-opening detecting step in FIG. 1.

FIG. 7 is another schematic view of the eye-opening detecting step in FIG. 1.

### DETAILED DESCRIPTION

Embodiments of the present disclosure will be described below with reference to the drawings. For the sake of clarity, many practical details will be explained together in the following statements. However, it should be understood that these practical details should not be used to limit the present disclosure. That is, these practical details are not necessary in embodiments of the present disclosure. In addition, for the sake of simplifying the drawings, some commonly used structures and components are shown in the drawings in a simple schematic manner; and repeated components may be represented by the same numbers.

In addition, the terms first, second, etc. are used herein to describe various elements or components, these elements or components should not be limited by these terms. Consequently, a first element or component discussed below could be termed a second element or component. Moreover, the combination of components in the present disclosure is not a combination that is generally known, conventional or customary in this field. The components themselves being or being not common knowledge cannot be used to determine whether the combination relationship can be easily completed by a person skilled in the technical field.

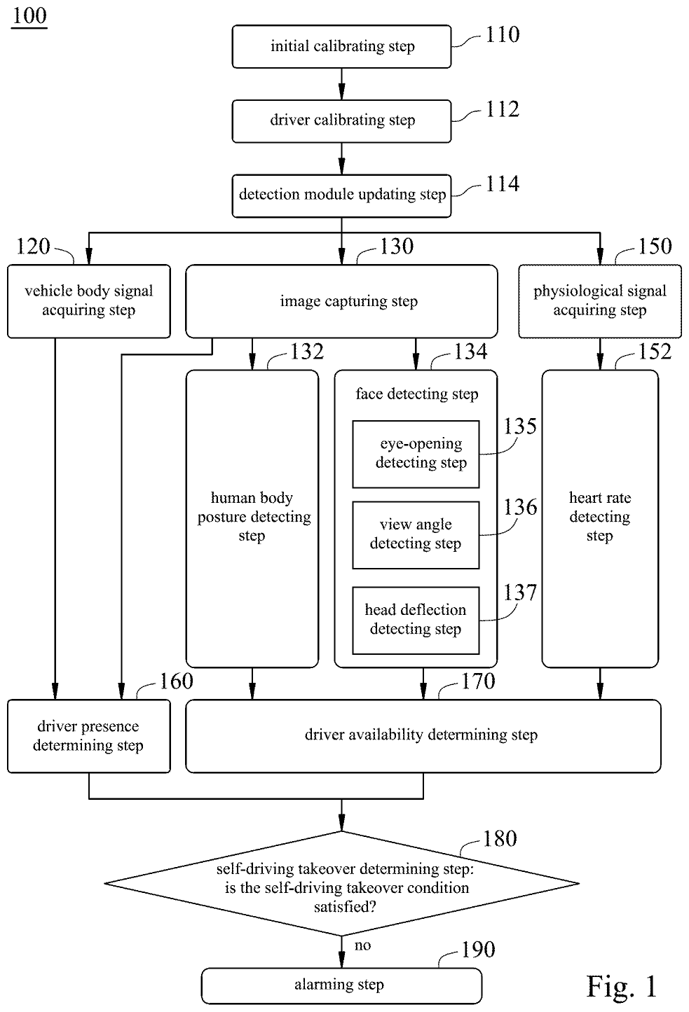

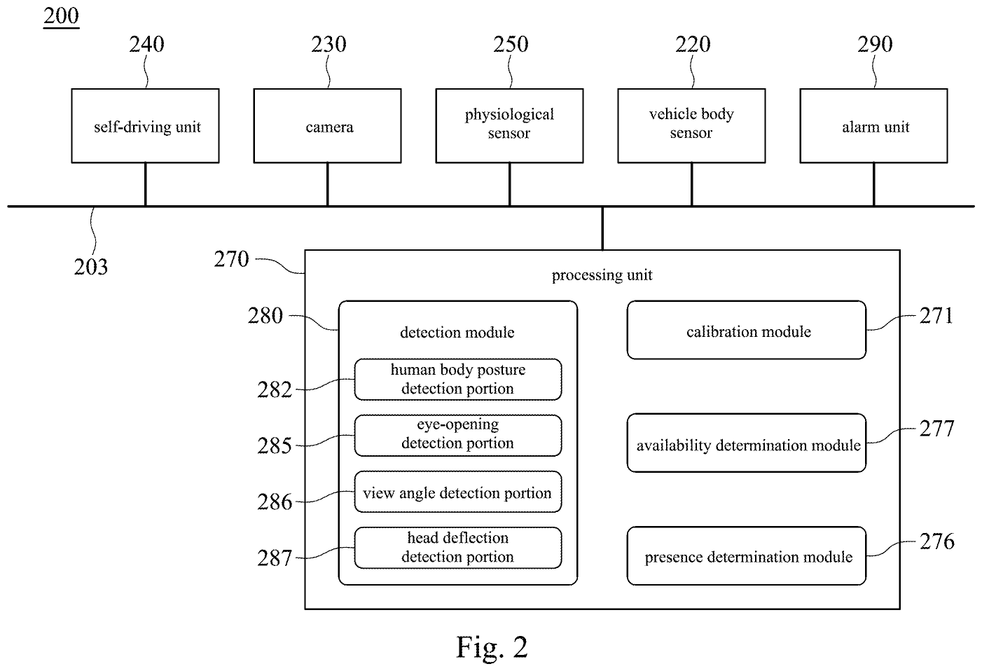

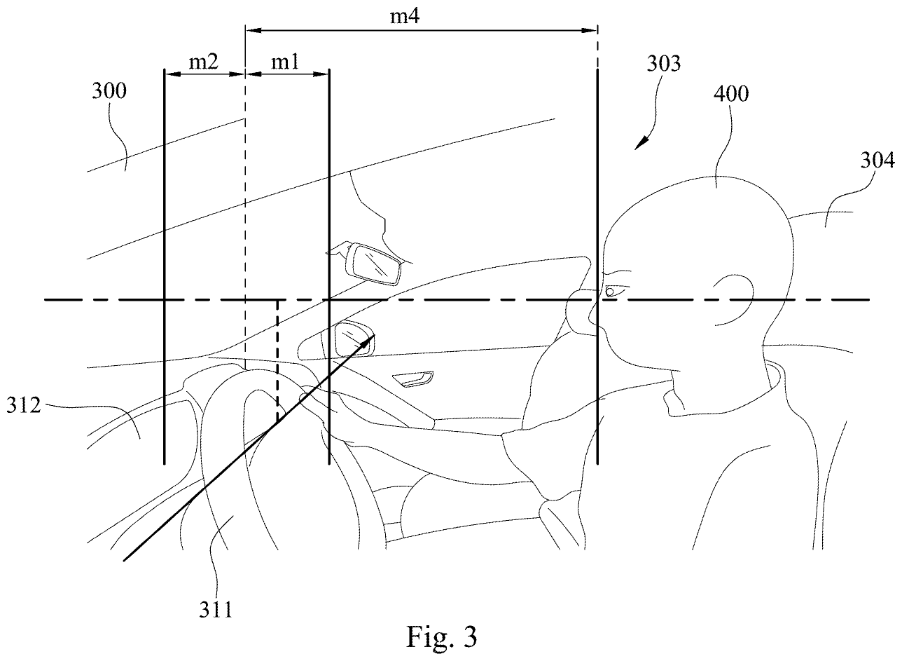

FIG. 1 is a flow chart of a self-driving takeover determining method 100 according to the 1st embodiment of the present disclosure, FIG. 2 is a block diagram of a self-driving takeover determining system 200 according to the 2nd embodiment of the present disclosure, and FIG. 3 is a schematic view of a vehicle 300, on which the self-driving takeover determining system 200 in FIG. 2 is disposed. With reference to FIG. 1 to FIG. 3, the self-driving takeover determining method 100 of the 1st embodiment and the self-driving takeover determining system 200 of the 2nd embodiment will be described together. The self-driving takeover determining method 100 is for determining whether a driver 400 located on a driver's seat 304 in a vehicle 300 satisfies a self-driving takeover condition (i.e., whether satisfying a safe self-driving condition by the vehicle 300) in a self-driving mode. The vehicle 300 may be a Level 3 self-driving vehicle, and the scenarios of the self-driving takeover includes the driver 400 initiating the self-driving takeover of the vehicle 300 and the driving right transferred to the driver 400 from the self-driving mode. The self-driving takeover determining method 100 includes a driver calibrating step 112, a detection module updating step 114, an image capturing step 130, a face detecting step 134, a driver availability determining step 170 and a self-driving takeover determining step 180.

The driver calibrating step 112 includes, before entering the self-driving mode of the vehicle 300, capturing a plurality of calibration images of the driver 400 by at least one camera 230 and generating a plurality of driver calibration parameters by a calibration module (i.e., a calibration program) 271 according to the calibration images, and the driver calibration parameters are a plurality of relative position parameters of the driver 400 in a cockpit 303 of the vehicle 300. The detection module updating step 114 includes updating a detection module 280 according to the driver calibration parameters. Therefore, the self-calibration mechanism is advantageous in adapting to the variations in height, seat distance, etc. of the different drivers 400 to automatically adjust the reasonable front field of view.

The image capturing step 130 includes, during a first detection time period in the self-driving mode, capturing a plurality of driver images (image frames) of the driver 400 by the camera 230, and the driver images may be visible or infrared light images. The face detecting step 134 includes, by the detection module 280 according to the driver images, detecting whether the driver 400 satisfies at least one face characteristic condition, which is at least one face detection result.

The driver availability determining step 170 includes, by an availability determination module 277 according to the at least one face detection result, determining whether the driver 400 satisfies an availability condition, which is an availability determination result. The self-driving takeover determining step 180 includes determining whether the self-driving takeover condition is satisfied according to the availability determination result. Therefore, it is beneficial to accurately detect whether the driver 400 has the ability to take over the driving task to increase the safety of the self-driving system.

With reference to FIG. 2 and FIG. 3, the self-driving takeover determining system 200 of the 2nd embodiment is disposed on the vehicle 300 and includes a self-driving unit 240, the at least one camera 230, a processing unit 270 and an on-board communication network 203. The self-driving unit 240 is configured for executing the self-driving mode of the vehicle 300. The camera 230 is configured for capturing the driver images of the driver 400 located on the driver's seat 304 in the vehicle 300. The processing unit 270 includes the calibration module 271, the detection module 280 and the availability determination module 277. The on-board communication network 203 is configured for communicatively connecting the self-driving unit 240, the camera 230 and the processing unit 270.

The processing unit 270 is configured to: before entering the self-driving mode of the vehicle 300, capture the calibration images of the driver 400 by the camera 230 and generate the driver calibration parameters by the calibration module 271 according to the calibration images, wherein the driver calibration parameters are the relative position parameters of the driver 400 in the cockpit 303 of the vehicle 300; update the detection module 280 according to the driver calibration parameters; during the first detection time period in the self-driving mode, capture the driver images of the driver 400 by the camera 230; by the detection module 280 according to the driver images, detect whether the driver 400 satisfies the at least one face characteristic condition, which is the at least one face detection result; by the availability determination module 277 according to the at least one face detection result, determine whether the driver 400 satisfies the availability condition, which is the availability determination result; and determine whether the self-driving takeover condition is satisfied according to the availability determination result. Therefore, it is beneficial to properly and accurately detect whether the driver 400 of the Level 3 self-driving vehicle has the ability to take over the driving task.

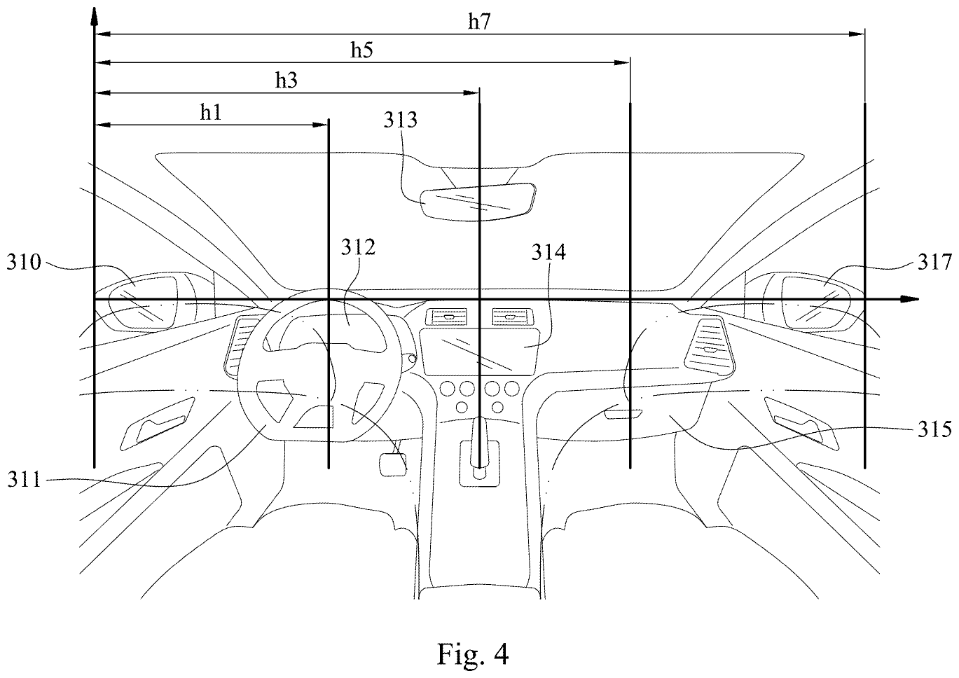

FIG. 4 is another schematic view of the vehicle 300, on which the self-driving takeover determining system 200 in FIG. 2 is disposed. With reference to FIG. 3 and FIG. 4, the driver calibration parameters may include a sight range related information of the driver 400, a lateral distance (e.g., lateral distances h1, h3, h5, h7) and a longitudinal distance (e.g., longitudinal distances m1, m2, m4) between the driver 400 and at least one target object among a rearview mirror 313, a left rearview mirror 310, a right rearview mirror 317, a carputer 314, a steering wheel 311, an instrument panel 312 and a glove compartment 315 of the vehicle 300. Therefore, the self-calibration mechanism is advantageous in adapting to the different drivers 400 to automatically adjust the reasonable front field of view. Specifically, the sight range of the driver 400 can include the consideration of the head deflection angle. That is, the sight range integrates the states of whether the head deflects (rotates) and includes the sight movement range of the head deflection state (owl pose) and the sight movement range of the head non-deflection state (lizard pose).

In detail, the self-driving takeover determining method 100 may further include an initial calibrating step 110, which is for the vehicle 300 being an unknown or new model. The initial calibrating step 110 includes capturing an image of an initial driver (which can be the same as or different from the driver 400) and find the region of interest (ROI) or a face position, providing the instruction to cause the initial driver located on the driver's seat 304 to perform at least one action of directly looking at the at least one target object according to the initial calibration operation instruction of the calibration module 271, capturing at least one initial calibration image of the at least one action by the camera 230, and generating a plurality of initial calibration parameters by the calibration module 271. The initial calibration parameters include a view angle of the initial driver directly looking at the at least one target object. The driver calibrating step 112 is for the vehicle 300 being a known model. The driver calibrating step 112 includes generating the driver calibration parameters by the calibration module 271 according to the initial calibration parameters and the calibration images, and the driver calibration parameters include a view angle of the driver 400 directly looking at the at least one target object. Therefore, it is advantageous in updating the detection module 280 according to the driver calibration parameters of the different drivers 400 in the detection module updating step 114.

In the initial calibrating step 110, for example, with reference to FIG. 3, an upper end point of the steering wheel 311 is set as an origin. The longitudinal distance m1 between a center point of the steering wheel 311 and the origin, the longitudinal distance m2 between the instrument panel 312 and the origin, and the longitudinal distance m4 between the face of the driver 400 and the origin can be obtained, and the longitudinal distances m1, m2, m4 may be 0.1 m, 0.1 m and 0.45 m, respectively; with reference to FIG. 4, the left rearview mirror 310 is set as an origin, the lateral distance h1 between the driver 400 (or the steering wheel 311, the instrument panel 312, and the pedal) and the origin, the lateral distance h3 between the carputer 314 (or the rearview mirror 313) and the origin, the lateral distance h5 between the glove compartment 315 and the origin, and the lateral distance h7 between the right rearview mirror 317 and the origin can be obtained, and the lateral distances h1, h3, h5, h7 may be 0.75 m, 1.1 m, 1.45 m, 2.1 m, respectively; in the initial calibrating step 110, it can be obtained that the view angles of the initial driver looking directly at the rearview mirror 313 are 37 degrees rightward and 24 degrees upward, the view angles of the initial driver looking directly at the left rearview mirror 310 are 60 degrees leftward and 6 degrees downward, the view angles of the initial driver looking directly at the right rearview mirror 317 are 71 degrees rightward and 6 degrees downward, the view angles of the initial driver looking directly at the carputer 314 are 37 degrees rightward and 18 degrees downward, the view angle of the initial driver looking directly at the steering wheel 311 is 29 degrees downward, the view angle of the initial driver looking directly at the instrument panel 312 is 18 degrees downward, and the view angles of the initial driver looking directly at the glove compartment 315 are 55 degrees rightward and 33 degrees downward. The aforementioned longitudinal distances, lateral distances, and view angles can be derived from each other using trigonometric functions. When the driver 400 in the driver calibrating step 112 is different from the initial driver, the initial calibration parameters and calibration images can be used to generate the driver calibration parameters applying to the driver 400.

Therefore, the key positions, line of sight, and view angle ranges of the different vehicle models and the different drivers 400 during driving are not fixed values. The factors that affect the values may be the height, body shape, face shape and the seating habit of the driver 400, or the mechanism design, installation position, etc. of the vehicle 300. The driver calibrating step 112 is advantageous in obtaining the key position distance information from the structural parameters of the vehicle 300, and dynamically calculating the view angles of the key positions according to the position of the driver 400, so as to perform a wide range of detection by the self-driving takeover determining system 200 disposed on the Level 3 self-driving vehicle 300, cover situations of the head posture not facing directly, improve the overall detection rate, and distinguish from the Level 0 to Level 2 self-driving modes that determine as an abnormality while detecting a face without facing directly.

With reference to FIG. 1 and FIG. 2, the detection module 280 may include an eye-opening detection portion 285, a view angle detection portion 286 and a head deflection detection portion 287 (for detecting the head deflection angle and/or pose), which are all detection algorithms based on a machine learning (e.g., an image machine learning). The face detecting step 134 may include an eye-opening detecting step 135, a view angle detecting step 136 and a head deflection detecting step 137, which all include image pre-processing. The eye-opening detecting step 135 includes, by the eye-opening detection portion 285 of the detection module 280 according to the driver images, detecting whether the driver 400 satisfies an eye-opening characteristic condition, which is an eye-opening detection result. The view angle detecting step 136 includes, by the view angle detection portion 286 of the detection module 280 according to the driver images, detecting whether the driver 400 satisfies a view angle characteristic condition, which is a view angle detection result. For example, in a second detection time period of the first detection time period, the sight of driver 400 falls within the specified range formed by the target objects of the rearview mirror 313, the left rearview mirror 310, the right rearview mirror 317, the carputer 314, the steering wheel 311, the instrument panel 312 and the glove compartment 315 can be defined as satisfying the view angle characteristic condition. The head deflection detecting step 137 includes, by the head deflection detection portion 287 of the detection module 280 according to the driver images, detecting whether the driver 400 satisfies a head deflection characteristic condition, which is a head deflection detection result. For example, the head of the driver 400 deflects within the specified range formed by the target objects of the rearview mirror 313, the left rearview mirror 310, the right rearview mirror 317, the carputer 314, the steering wheel 311, the instrument panel 312 and the glove compartment 315 can be defined as satisfying the head deflection characteristic condition. A number of the at least one face detection result is at least three, and the face detection results include the eye-opening detection result, the view angle detection result and the head deflection detection result. Therefore, it is beneficial to accurately detect whether the driver 400 has the ability to take the over driving task.

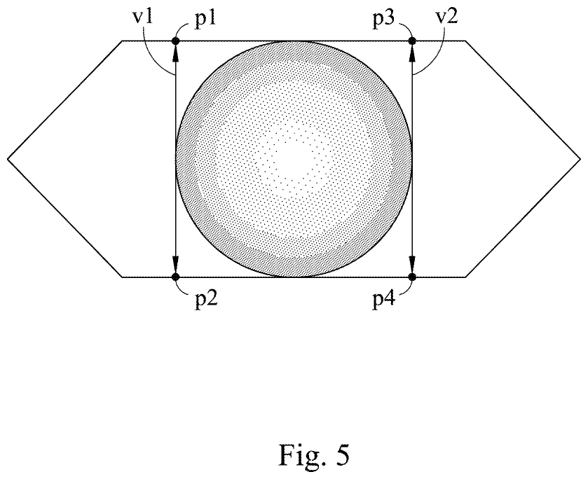

FIG. 5 is a schematic view of an eye state characteristic value in the eye-opening detecting step 135 in FIG. 1. With reference to FIG. 1 and FIG. 5, the eye-opening detecting step 135 may include, based on a Euclidean distance algorithm, establishing a first vertical distance v1 according to a first eye upper point p1 and a first eye lower point p2 of each of two eyes in each of the driver images and a second vertical distance v2 according to a second eye upper point p3 and a second eye lower point p4 thereof, and an eye state characteristic value is defined as a maximum of the two first vertical distances v1 and the two second vertical distances v2 of the two eyes (a total of four vertical distances). The eye state characteristic value being greater than an eye-opening threshold is defined as satisfying an eye-opening state. The eye-opening threshold is determined according to the eye-opening detection portion 285 being updated of the detection module 280 and is within a threshold setting range (e.g., between 6 pixels and 15 pixels), and whether the eye-opening state is satisfied is for detecting whether the driver 400 satisfies the eye-opening characteristic condition in the first detection time period. Therefore, whether the driver 400 has the ability to take over the driving task can be determined via the effective eye-opening detection result.

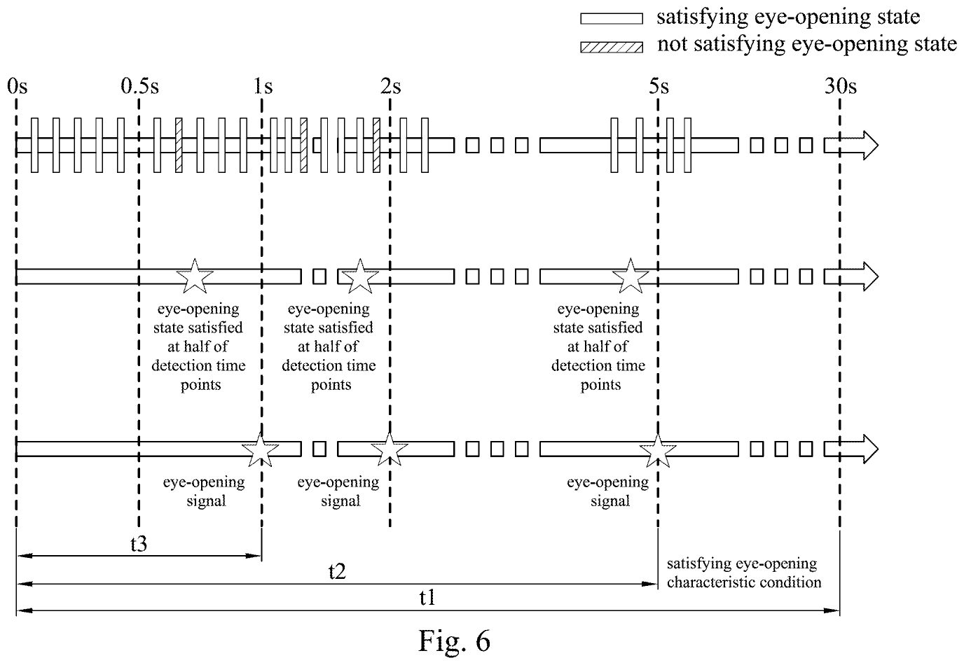

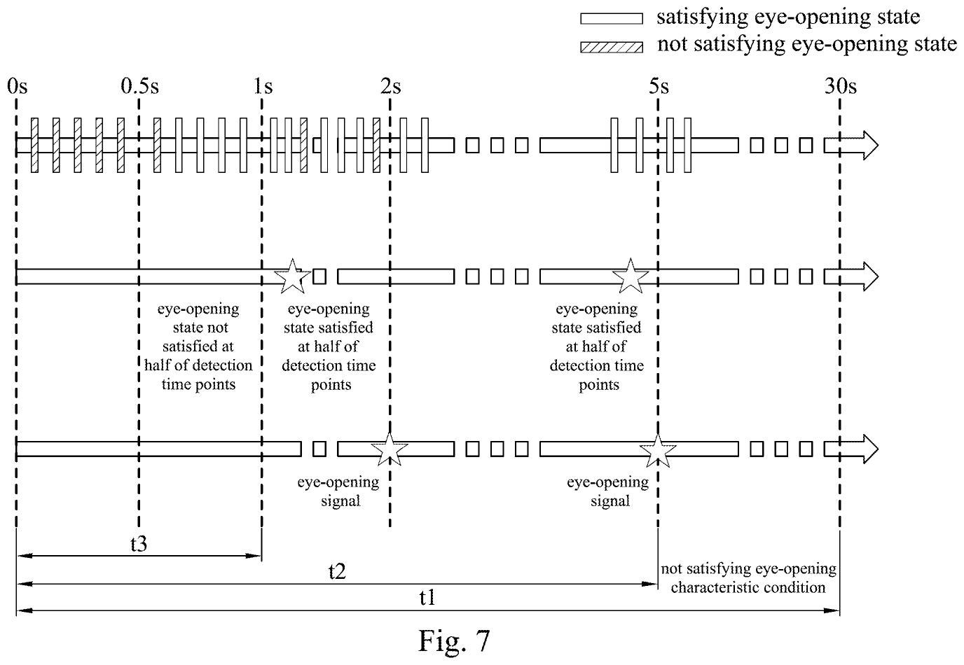

FIG. 6 is a schematic view of the eye-opening detecting step 135 in FIG. 1, and FIG. 7 is another schematic view of the eye-opening detecting step 135 in FIG. 1. With reference to FIG. 6 and FIG. 7, the first detection time period t1 may include a plurality of second detection time periods t2, and each of the second detection time periods t2 may include a plurality of third detection time periods t3. The first detection time period t1 may be between 1 second and 30 seconds, each of the second detection time periods t2 may be between 1 second and 5 seconds, and each of the third detection time periods t3 may be between 0.5 seconds and 1 second. Each of the third detection time periods t3 includes a plurality of detection time points. The eye-opening detecting step 135 includes detecting whether the driver 400 satisfies an eye-opening state at one of the detection time points. When the eye-opening state is satisfied at more than or equal to half of the detection time points of one of the third detection time periods t3, an eye-opening signal corresponding to the one of the third detection time periods t3 is generated. For example, the first detection time period t1 is 30 seconds, each of the second detection time periods t2 is 5 seconds, and each of the third detection time periods t3 is 1 second. As shown in FIG. 6, when each of the third detection time periods t3 of one of the second detection time periods t2 (0 s to 5 s in FIG. 6) corresponds to the eye-opening signal, the driver 400 is detected as satisfying the eye-opening characteristic condition in the first detection time period t1 (even though 5 s to 30 s in FIG. 6 does not correspond to the eye-opening signal). On the contrary, as shown in FIG. 7, when at least one of the third detection time periods t3 (0 s to 1 s in FIG. 7) of one of the second detection time periods t2 does not correspond to the eye-opening signal and 5 s to 30 s in FIG. 7 also does not correspond to the eye-opening signal, the driver 400 is detected as not satisfying the eye-opening characteristic condition in the first detection time period t1. Therefore, an accurate eye-opening detection of the present disclosure can be achieved.

With reference to FIG. 1, the view angle detecting step 136 may include recognizing a pupil in each of the driver images and detecting whether the driver 400 satisfies a specified view angle range via a coordinate conversion formula (e.g., Rodrigues' rotation formula), and whether the driver 400 satisfies the specified view angle range is for detecting whether the driver 400 satisfies the view angle characteristic condition in the first detection time period t1. The head deflection detecting step 137 may include recognizing a nose tip in each of the driver images and detecting whether the driver 400 satisfies a specified head deflection range via a coordinate conversion formula (e.g., Rodrigues' rotation formula), and whether the driver 400 satisfies the specified head deflection range is for detecting whether the driver 400 satisfies the head deflection characteristic condition in the first detection time period t1. Therefore, whether the driver 400 has the ability to take over the driving task can be determined via the effective view angle detection result and head deflection detection result.

When each of the third detection time periods t3 of one of the second detection time periods t2 corresponds to a view angle signal that means satisfying the specified view angle range, the driver 400 may be detected as satisfying the view angle characteristic condition in the first detection time period t1. When each of the third detection time periods t3 of one of the second detection time periods t2 corresponds to a head deflection signal that means satisfying the specified head deflection range, the driver 400 may be detected as satisfying the head deflection characteristic condition in the first detection time period t1. Therefore, accurate view angle and head deflection detections of the present disclosure can be achieved.

The self-driving takeover determining method 100 may further include a physiological signal acquiring step 150, a human body posture detecting step 132 and a heart rate detecting step 152, and may further include a respiration detecting step (not shown in drawings). The self-driving takeover determining system 200 may further include at least one physiological sensor 250 (e.g., bioradar). The physiological signal acquiring step 150 includes, during the first detection time period t1 in the self-driving mode, by the physiological sensor 250, acquiring a plurality of physiological signals of the driver 400, which include a plurality of heart rate signals and/or a plurality of respiratory signals. The human body posture detecting step 132 includes, by a human body posture detection portion 282 of the detection module 280 according to the driver images, integrating the face and body images of the driver 400 via deep learning algorithms and extracting posture feature points, so as to detect whether the driver 400 satisfies a non-sleeping posture characteristic condition, which is a non-sleeping posture detection result. The heart rate detecting step 152 includes, by the detection module 280 according to the physiological signals, detecting whether the driver 400 satisfies a heart rate characteristic condition, which is a heart rate detection result. The driver availability determining step 170 includes, by the availability determination module 277 according to the face detection results, the non-sleeping posture detection result and the heart rate detection result, determining whether the driver 400 satisfies the availability condition, which is the availability determination result. Therefore, with the assistance of physiological sensor 250 such as the bioradar, the problem of physiological signs that cannot be detected by simply using the camera 230 is solved (e.g., the heart rate and respiratory images are limited by light sources, obstructions and the actions of the driver 400), so as to improve the accuracy of the driver availability and avoid misjudgments due to the image losing the characteristics of the driver 400.

A number of the at least one face characteristic condition may be plural. When the driver 400 satisfies at least two of the face characteristic conditions or/and satisfies one or both of the non-sleeping posture characteristic condition and the heart rate characteristic condition, and a detection result weight sum is greater than a weight sum threshold, the driver 400 is determined to satisfy the availability condition by the availability determination module 277. Furthermore, a weight coefficient of each of the face detection results is greater than a weight coefficient of the non-sleeping posture detection result and a weight coefficient of the heart rate detection result. Therefore, in the availability detection, the detection accuracies of the images and physiological signals are the core of all. However, in practical applications, the external light source interference, environmental change, appearance of driver 400, etc. would affect the detection accuracies. According to the self-driving takeover determining system 200 of the present disclosure, a feature classifier is proposed. The weight of the feature classifier is allocated so that the image and the physiological signal complement each other to avoid over-reliance on a single feature, resulting in the loss of availability detection function due to poor recognition.

For example, with reference to the following Table 1, when the driver 400 satisfies two of the face characteristic conditions (eye-opening state≥Sth seconds, view angle falling within the specified range≥Sth seconds) and one of the physiological characteristic conditions (heart rate higher than 50 times/minute≥Sth seconds), and a detection result weight sum calculated according thereto is greater than the weight sum threshold, the driver 400 is determined to satisfy the availability condition by the availability determination module 277. The aforementioned Sth seconds are the second detection time period t2, and Sth seconds may be between 1 second and 5 seconds.

TABLE 1
Characteristic detection of driver (30
seconds of detection time period)

| Physiological characteristic | | Face characteristic | | |
|---|---|---|---|---|
| conditions | | conditions | | |
| Human body | | | Head | |
| posture | Heart rate | Eye opening | deflection | View angle |
| Non-sleeping | Heart rate | Eye-opening | Head | View angle |
| state ≥ Sth | higher than 50 | state ≥ Sth | deflection | within |
| seconds | times/minute ≥ | seconds | within | specified |
| | Sth seconds | | specified | range ≥ Sth |
| | | | range ≥ Sth | seconds |
| | | | seconds | |
| | V | V | | V |
| | ↓ | ↓ | | ↓ |

Availability determination module (weight-based classifier)
↓
Satisfying availability condition

with reference to the following Table 2, when the driver 400 satisfies none of the face characteristic conditions and two of the physiological characteristic conditions (non-sleeping posture≥Sth seconds, heart rate higher than 50 times/minute≥Sth seconds), and a detection result weight sum calculated according thereto is smaller than the weight sum threshold, the driver 400 is determined to not satisfy the availability condition by the availability determination module 277. The aforementioned Sth seconds are the second detection time period t2, and Sth seconds may be between 1 second and 5 seconds.

TABLE 2
Characteristic detection of driver (30 seconds
of detection time period) conditions

| Physiological characteristic | | Face characteristic | | |
|---|---|---|---|---|
| conditions | | conditions | | |
| Human body | | | Head | |
| posture | Heart rate | Eye opening | deflection | View angle |
| Non-sleeping | Heart rate | Eye-opening | Head | View angle |
| state ≥ Sth | higher than 50 | state ≥ Sth | deflection | within |
| seconds | times/minute ≥ | seconds | within | specified |
| | Sth seconds | | specified | range ≥ Sth |
| | | | range ≥ Sth | seconds |
| | | | seconds | |
| V | V | | | |
| ↓ | ↓ | | | |

Availability determination module (weight-based classifier)
↓
Not satisfying availability condition

The self-driving takeover determining method 100 may further include a vehicle body signal acquiring step 120, a driver presence determining step 160 and an alarming step 190. The self-driving takeover determining system 200 may further include at least one vehicle body sensor 220 and an alarm unit 290, and the processing unit 270 may further include a presence determination module 276. The vehicle body signal acquiring step 120 includes, during the first detection time period t1 in the self-driving mode, by the at least one vehicle body sensor 220, acquiring a plurality of vehicle body signals of the driver's seat 304, which include at least partial signals of a plurality of seat belt buckle signals and a plurality of driver's seat pressure signals. The driver presence determining step 160 includes, by the presence determination module 276 according to at least one of the driver images, the vehicle body signals and the physiological signals, determining whether the driver 400 satisfies a presence condition, which is a presence determination result. The self-driving takeover determining step 180 includes determining whether the self-driving takeover condition is satisfied according to the availability determination result and the presence determination result. When the self-driving takeover condition is not satisfied in the self-driving takeover determining step 180 (i.e., at least one of the presence condition and the availability condition is not satisfied), the alarming step 190 includes generating at least one of a visual alarm, an auditory alarm and a vibration alarm to alarm the driver 400. Therefore, the presence condition satisfied means that the driver 400 is on the driver's seat 304, and the availability condition satisfied means that the driver 400 has the ability to take over the driving task. When the driver 400 does not satisfy at least one of the presence condition and the availability condition, that is, the driver 400 temporarily loses the ability to take over control (such as falling asleep), or the vehicle 300 is in a state that requires the driver 400 to take over control (such as the self-driving state is terminated), the alarm unit 290 will issue a warning. If there is no improvement after the warning, the self-driving unit 240 will perform minimal risk actions to ensure the safety of the self-driving system of the vehicle 300.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A self-driving takeover determining method, for determining whether a driver located on a driver's seat in a vehicle satisfies a self-driving takeover condition in a self-driving mode, and the self-driving takeover determining method comprising:
a driver calibrating step comprising, before entering the self-driving mode of the vehicle, capturing a plurality of calibration images of the driver by at least one camera and generating a plurality of driver calibration parameters by a calibration module according to the calibration images, wherein the driver calibration parameters are a plurality of relative position parameters of the driver in a cockpit of the vehicle;
a detection module updating step comprising updating a detection module according to the driver calibration parameters;
an image capturing step comprising, during a first detection time period in the self-driving mode, capturing a plurality of driver images of the driver by the camera;
a face detecting step comprising, by the detection module according to the driver images, detecting whether the driver satisfies at least one face characteristic condition, which is at least one face detection result;
a driver availability determining step comprising, by an availability determination module according to the at least one face detection result, determining whether the driver satisfies an availability condition, which is an availability determination result; and
a self-driving takeover determining step comprising determining whether the self-driving takeover condition is satisfied according to the availability determination result.

2. The self-driving takeover determining method of claim 1, further comprising:
a vehicle body signal acquiring step comprising, during the first detection time period in the self-driving mode, by at least one vehicle body sensor, acquiring a plurality of vehicle body signals of the driver's seat, which comprise at least partial signals of a plurality of seat belt buckle signals and a plurality of driver's seat pressure signals;
a driver presence determining step comprising, by a presence determination module according to at least one of the driver images and the vehicle body signals, determining whether the driver satisfies a presence condition, which is a presence determination result; and
an alarming step;
wherein the self-driving takeover determining step comprises determining whether the self-driving takeover condition is satisfied according to the availability determination result and the presence determination result;
wherein when the self-driving takeover condition is not satisfied in the self-driving takeover determining step, the alarming step comprises generating at least one of a visual alarm, an auditory alarm and a vibration alarm to alarm the driver.

3. The self-driving takeover determining method of claim 1, further comprising:
a physiological signal acquiring step comprising, during the first detection time period in the self-driving mode, by at least one physiological sensor, acquiring a plurality of physiological signals of the driver, which comprise at least one of a plurality of heart rate signals and a plurality of respiratory signals;
a human body posture detecting step comprising, by the detection module according to the driver images, detecting whether the driver satisfies a non-sleeping posture characteristic condition, which is a non-sleeping posture detection result; and
a heart rate detecting step comprising, by the detection module according to the physiological signals, detecting whether the driver satisfies a heart rate characteristic condition, which is a heart rate detection result;
wherein the driver availability determining step comprises, by the availability determination module according to the at least one face detection result, the non-sleeping posture detection result and the heart rate detection result, determining whether the driver satisfies the availability condition, which is the availability determination result.

4. The self-driving takeover determining method of claim 3, wherein a number of the at least one face characteristic condition is plural, when the driver satisfies at least two of the face characteristic conditions or satisfies the non-sleeping posture characteristic condition and the heart rate characteristic condition, and a detection result weight sum is greater than a weight sum threshold, the driver is determined to satisfy the availability condition by the availability determination module;
wherein a weight coefficient of each of the face detection results is greater than a weight coefficient of the non-sleeping posture detection result and a weight coefficient of the heart rate detection result.

5. The self-driving takeover determining method of claim 1, wherein the driver calibration parameters comprise a sight range related information of the driver, a lateral distance and a longitudinal distance between the driver and at least one target object among a rearview mirror, a left rearview mirror, a right rearview mirror, a carputer, a steering wheel, an instrument panel and a glove compartment of the vehicle.

6. The self-driving takeover determining method of claim 5, further comprising:
an initial calibrating step comprising causing an initial driver located on the driver's seat to perform at least one action of directly looking at the at least one target object according to an initial calibration operation instruction of the calibration module, capturing at least one initial calibration image of the at least one action by the camera, and generating a plurality of initial calibration parameters by the calibration module, wherein the initial calibration parameters comprise a view angle of the initial driver directly looking at the at least one target object;
wherein the driver calibrating step comprises generating the driver calibration parameters by the calibration module according to the initial calibration parameters and the calibration images, and the driver calibration parameters comprise a view angle of the driver directly looking at the at least one target object.

7. The self-driving takeover determining method of claim 1, wherein the detection module comprises an eye-opening detection portion, a view angle detection portion and a head deflection detection portion, which are all detection algorithms based on a machine learning;
wherein the face detecting step comprises:
an eye-opening detecting step comprising, by the eye-opening detection portion of the detection module according to the driver images, detecting whether the driver satisfies an eye-opening characteristic condition, which is an eye-opening detection result;
a view angle detecting step comprising, by the view angle detection portion of the detection module according to the driver images, detecting whether the driver satisfies a view angle characteristic condition, which is a view angle detection result; and
a head deflection detecting step comprising, by the head deflection detection portion of the detection module according to the driver images, detecting whether the driver satisfies a head deflection characteristic condition, which is a head deflection detection result;
wherein a number of the at least one face detection result is at least three, and the face detection results comprise the eye-opening detection result, the view angle detection result and the head deflection detection result.

8. The self-driving takeover determining method of claim 7, wherein the eye-opening detecting step comprises, based on a Euclidean distance algorithm, establishing a first vertical distance according to a first eye upper point and a first eye lower point of each of two eyes in each of the driver images and a second vertical distance according to a second eye upper point and a second eye lower point thereof, and an eye state characteristic value is defined as a maximum of the two first vertical distances and the two second vertical distances of the two eyes;
wherein the eye state characteristic value being greater than an eye-opening threshold is defined as satisfying an eye-opening state, the eye-opening threshold is determined according to the eye-opening detection portion being updated of the detection module and is within a threshold setting range, and whether the eye-opening state is satisfied is for detecting whether the driver satisfies the eye-opening characteristic condition in the first detection time period.

9. The self-driving takeover determining method of claim 7, wherein the view angle detecting step comprises recognizing a pupil in each of the driver images and detecting whether the driver satisfies a specified view angle range via a coordinate conversion formula, and whether the driver satisfies the specified view angle range is for detecting whether the driver satisfies the view angle characteristic condition in the first detection time period;
wherein the head deflection detecting step comprises recognizing a nose tip in each of the driver images and detecting whether the driver satisfies a specified head deflection range via a coordinate conversion formula, and whether the driver satisfies the specified head deflection range is for detecting whether the driver satisfies the head deflection characteristic condition in the first detection time period.

10. The self-driving takeover determining method of claim 7, wherein the first detection time period comprises a plurality of second detection time periods, each of the second detection time periods comprises a plurality of third detection time periods, the first detection time period is between 1 second and 30 seconds, each of the second detection time periods is between 1 second and 5 seconds, and each of the third detection time periods is between 0.5 seconds and 1 second;
wherein each of the third detection time periods comprises a plurality of detection time points, the eye-opening detecting step comprises detecting whether the driver satisfies an eye-opening state at one of the detection time points, and when the eye-opening state is satisfied at more than or equal to half of the detection time points of one of the third detection time periods, an eye-opening signal corresponding to the one of the third detection time periods is generated;
wherein when each of the third detection time periods of one of the second detection time periods corresponds to the eye-opening signal, the driver is detected as satisfying the eye-opening characteristic condition in the first detection time period.

11. The self-driving takeover determining method of claim 10, wherein when each of the third detection time periods of one of the second detection time periods corresponds to a view angle signal that means satisfying a specified view angle range, the driver is detected as satisfying the view angle characteristic condition in the first detection time period;
wherein when each of the third detection time periods of one of the second detection time periods corresponds to a head deflection signal that means satisfying a specified head deflection range, the driver is detected as satisfying the head deflection characteristic condition in the first detection time period.

12. A self-driving takeover determining system, disposed on a vehicle, and comprising:
a self-driving unit configured for executing a self-driving mode of the vehicle;
at least one camera configured for capturing a plurality of driver images of a driver located on a driver's seat in the vehicle;
a processing unit comprising a calibration module, a detection module and an availability determination module; and
an on-board communication network configured for communicatively connecting the self-driving unit, the camera and the processing unit;
wherein the processing unit is configured to:
before entering the self-driving mode of the vehicle, capture a plurality of calibration images of the driver by at least one camera and generate a plurality of driver calibration parameters by the calibration module according to the calibration images, wherein the driver calibration parameters are a plurality of relative position parameters of the driver in a cockpit of the vehicle;
update the detection module according to the driver calibration parameters;
during a first detection time period in the self-driving mode, capture a plurality of driver images of the driver by the camera;
by the detection module according to the driver images, detect whether the driver satisfies at least one face characteristic condition, which is at least one face detection result;
by the availability determination module according to the at least one face detection result, determine whether the driver satisfies an availability condition, which is an availability determination result; and
determine whether a self-driving takeover condition is satisfied according to the availability determination result.

13. The self-driving takeover determining system of claim 12, further comprising:
at least one vehicle body sensor;
at least one physiological sensor; and
an alarm unit;
wherein the processing unit further comprises a presence determination module and is configured to:
during the first detection time period in the self-driving mode, by the at least one physiological sensor, acquire a plurality of physiological signals of the driver, which comprise at least one of a plurality of heart rate signals and a plurality of respiratory signals;
by the detection module according to the driver images, detect whether the driver satisfies a non-sleeping posture characteristic condition, which is a non-sleeping posture detection result;
by the detection module according to the physiological signals, detect whether the driver satisfies a heart rate characteristic condition, which is a heart rate detection result;
by the availability determination module according to the at least one face detection result, the non-sleeping posture detection result and the heart rate detection result, determine whether the driver satisfies the availability condition, which is the availability determination result;
during the first detection time period in the self-driving mode, by the at least one vehicle body sensor, acquire a plurality of vehicle body signals of the driver's seat, which comprise at least partial signals of a plurality of seat belt buckle signals and a plurality of driver's seat pressure signals;
by the presence determination module according to at least one of the driver images and the vehicle body signals, determine whether the driver satisfies a presence condition, which is a presence determination result;
determine whether the self-driving takeover condition is satisfied according to the availability determination result and the presence determination result, wherein when the self-driving takeover condition is not satisfied, the alarm unit is configured to generate at least one of a visual alarm, an auditory alarm and a vibration alarm to alarm the driver.

14. The self-driving takeover determining system of claim 12, wherein the detection module comprises an eye-opening detection portion, a view angle detection portion and a head deflection detection portion, which are all detection algorithms based on a machine learning;
wherein the processing unit is configured to:
by the eye-opening detection portion of the detection module according to the driver images, detect whether the driver satisfies an eye-opening characteristic condition, which is an eye-opening detection result;
by the view angle detection portion of the detection module according to the driver images, detect whether the driver satisfies a view angle characteristic condition, which is a view angle detection result;
by the head deflection detection portion of the detection module according to the driver images, detect whether the driver satisfies a head deflection characteristic condition, which is a head deflection detection result;
wherein a number of the at least one face detection result is at least three, and the face detection results comprise the eye-opening detection result, the view angle detection result and the head deflection detection result.
